(19) United States
(12) Patent Application Publication
(10) Pub. No.: US 2007/0060658 A1
(43) Pub. Date: Mar. 15, 2007

(54) STABILIZATION OF ORGANOGELS AND HYDROGELS BY AZIDE-ALKYNE [3+2] CYCLOADDITION

(76) Inventors: David D. Diaz, Islas Canarias (ES); M. G. Finn, San Diego, CA (US); Valery V. Fokin, Oceanside, CA (US)

Correspondence Address: Edward P. Gamson, Suite 2200, 120 S. Riverside Plaza, Chicago, IL, 60606-3945, US

(21) Appl. No.: 11/465,970

(22) Filed: Aug. 21, 2006

Related U.S. Application Data
(60) Provisional application No. 60/712,932, filed on Aug. 31, 2005.

(51) Int. Cl. B01J 13/00

(52) U.S. Cl. 516/102

(57) ABSTRACT

Self-assembled gels were modified by the installation of azide and alkyne groups on the gelator and reaction with complementary reagents by the catalyzed azide-alkyne cycloaddition reaction. This is the first example of the use of a “click” reaction in such a supramolecular environment, and a new strategy for tuning the properties of gelled materials.

### CROSS-REFERENCE TO RELATED APPLICATION

This application is based on Ser. No. 60/712,932 on Aug. 31, 2005, whose disclosures are incorporated by reference.

### TECHNICAL FIELD

The present invention relates to a method for modifying a gel, and more particularly to a method for modifying or modulating the properties of an organogel or a hydrogel by reaction of a gelator molecule with a modulating molecule using a click chemistry azide-alkyne [3+2] cycloaddition.

### BACKGROUND ART

Gels are usually formed by dissolving a small amount (usually about 0.1 to about 10 weight percent) of a gelator in a hot solvent (water or organic solvent, or mixture). Upon cooling below the gel-to-sol transition temperature or temperature of gelation, T_{gel}, the complete volume of the solvent is immobilized and can support it own weight without collapsing. Gelation is often tested by inverting a test tube or vial of the material upside down, and if no flow is observed, the solution is said to have gelled. [Estroff et al., Chem. Rev. 2004 104:1201-1218.]

Organogels and hydrogels are thermoreversible, viscoelastic (soft) materials comprised of low molecular weight (mass) compounds often referred to simply as gelators or more formally as low molecular weight (mass) organic gelators (LMOGs) that self assemble in organic solvent or water, respectively, into fibers, strands or taped often of micrometer lengths and nanometer diameters. The entanglement of such structures gives complex three-dimensional networks that trap solvent molecules. [Abdallah et al., Adv. Mater. 2000, 12:1237-1247; Terech et al., Chem. Rev. 1997, 97:3133-3159; van Esch et al., Angew. Chem. Int. Ed. 2000, 39:2263-2266; Gronwald et al., Chem. Eur. J. 2001, 7:4328-4334] Gelators can increase the viscosity of the medium by a factor of 10¹⁰, immobilizing up to 10⁵ liquid molecules per gelator, and can be sensitive to a variety of stimuli. [Ilmain et al., Nature 1991, 349:400-401, and citations therein; Osada et al., Polymer Gels and Networks; Marcel Dekker: New York, 2002]

Although many aspects of mechanisms of gelation are uncertain, gelators appear to have certain features in common. The aggregation of gelator molecules into fibrous networks is driven by multiple weak interactions such as dipole-dipole, van der Waals, and hydrogen bonding. [Abdallah et al., Adv. Mater. 2000, 12:1237-1247; Terech et al., Chem. Rev. 1997, 97:3133-3159; van Esch et al., Angew. Chem. Int. Ed. 2000, 39:2263-2266; Gronwald et al., Chem. Eur. J. 2001, 7:4328-4334] Hydrogen bonding appears to be less important as a driving force for aggregation in water than organic solvents. [Estroff et al., Chem. Rev. 2004 104:1201-1218.] The noncovalent nature of these interactions distinguish organogels from polymer gels, which have three-dimensional structures created by cross-linked covalent bonds, but of course systems exist with both types of connections. [Aharoni, In Synthesis, Characterization, and Theory of Polymeric Networks and Gels; Aharoni, S. M., Ed.; Plenum: New York, 1992; Zubarev et al., Adv. Mater. 2002, 14:198-203] The study of new organic gelators has become a highly active research area in the last two decades; the most common components of these materials [Jeong et al., Langmuir 2005, 21:586-594, and citations therein] include cholesterol derivatives, [Terech et al., J. Phys. Chem. 1995, 99:9558-9566; Murata et al., J. Am. Chem. Soc. 1994, 116:6664-6676; James et al., Chem. Lett. 1994:273-276; Tamaoki et al., Langmuir 2000, 16:7545-7547; Willemen et al., Langmuir 2002, 18:7102-7106] amides/peptides/ureas, [Hanabusa et al., J. Chem. Soc., Chem. Commun. 1992, 1371-1375; de Vries et al., J. Chem. Soc., Chem. Commun. 1993, 238-240; Hanabusa et al., Angew. Chem. Int. Ed. 1996, 35:1949-1951; Hanabusa et al., Chem. Lett. 1997, 191-192; Carr et al., Tetrahedron Lett. 1998, 39:7447-7450; Tomiokaet al., J. Am. Chem. Soc. 2001, 123:11817-11818; van Esch et al., Chem. Eur. J. 1999, 5:937-950; Schmidt et al., Langmuir 2002, 18:5668-5672] and saccharides [Gronwald et al., Chem. Eur. J. 2001, 7:4328-4334].

The self-assembled nanostructures formed by organogelators have found use in functional materials [van Esch et al., Angew. Chem. Int. Ed. 2000, 39:2263-2266; Osada et al., Polymer Gels and Networks; Marcel Dekker: New York, 2002] such as sensors, [Choi et al., Analyst 2000, 125:301-305; Tolksdorf et al., Adv. Mater. 2001, 13:1307-1310; Yang et al., Chem. Commun. 2004, 2424-2425] electrophoretic and electrically conductive matrices, [Mizrahi et al., Anal. Chem. 2004, 76:5399-5404; Hanabusa et al., Chem. Mater. 1999, 11:649-655] and templates for cell growth [Chen et al., Cell Transplantation 2003, 12:160] or the growth of sol-gel structures. [Kobayashi et al., Bull. Chem. Soc. Jpn. 2000, 73:1913-1917; Junget al., Chem. Eur. J. 2000, 6:4552-4557; Jung et al., J. Chem. Soc. Perkin Trans. II 2000, 2393-2398; Jung et al., Angew. Chem. Int. Ed. 2000, 39:1862-1865]

For many applications, the improvement of gel strength and stability are crucial. Recently, several different methods for in situ enhancement of gel thermostability have been reported, including post-polymerization of gel fibers, [Tamaoki et al., Langmuir 2000, 16:7545-7547; de Loos et al., J. Am. Chem. Soc. 1997, 12675, 12676; Inoue et al., Chem. Lett. 1999, 429-430] the addition of polymers, [Ihara et al., Org. Biomol. Chem. 2003, 1:3004-3006; Hanabusa et al., Chem. Lett. 1999, 767-768; Kobayashi et al., Chem. Commun. 2001, 1038-1039; Numata et al., Chem. Lett. 2003, 32:308-309; Takashima et al., Chem. Lett. 2004, 33:890-891] the use of host-guest interactions, [Jung, et al., Tetrahedron Lett. 1999, 40:8395-8399: Kawano et al., Chem. Commun. 2003, 1352-1353] and the use of metal ion coordination. [Kimura, M.; Shirai, H. Chem. Lett. 2000, 1168-1169; Kawano et al., Chem. Lett. 2003, 32: 12-13].

“Click” chemistry represents a modular approach toward synthesis that uses only the most practical chemical transformations to make molecular connections with absolute fidelity. [Kolb et al., Angew. Chem. Int. Ed. 2001, 40:2004-2021] Broadly, click chemistry reactions are modular, give high yields, generate only inoffensive byproducts that can be removed by nonchromatographic methods, can be stereospecific, utilize simple reaction conditions for readily available starting materials, use no solvent or a benign solvent and provide simple product isolation. A click reaction achieves its characteristics by having a high thermodynamic driving force that is typically in excess of 20 kcal/mol. [Kolb et al., Angew. Chem. Int. Ed. 2001, 40:2004-2021].

The Huisgen 1,3-dipolar cycloaddition of alkynes and azides (AAC) [Huisgen, R. In 1,3-Dipolar Cycloaddition Chemistry, Padwa, A., Ed.; Wiley: New York, 1984; Vol. 1, p 1-176; Huisgen, Pure Appl. Chem. 1989, 61:613-628] to give substituted 1,2,3-triazoles has emerged as a powerful linking reaction in both uncatalyzed [Mock et al., J. Org. Chem. 1983, 48:3619-3620; Lewis et al., Angew. Chem. Int. Ed. 2002, 41:1053-1057; Wang et al., Chem. Commun. 2003, 2450-2451] and copper(I)-catalyzed [Rostovtsev et al., Angew. Chem. Int. Ed. 2002, 41:2596-2599; Tornøe et al., J. Org. Chem. 2002, 67:3057-3062] forms. More recently, Zhang et al., J. Am. Chem. Soc. 2005, 127:15998-15999, reported that ruthenium(II) complexes could also be used to catalyze the formation of substituted 1,2,3-triazoles.

The practical importance of the process derives from the easy introduction of azides and alkynes groups into organic compounds and the fact that it is the only facile 1,3-dipolar reaction that uses chemically stable components: others generally employ at least one reactant that is highly energetic, water-sensitive, or transient in nature. [Carruthers In Cycloaddition Reactions in Organic Synthesis; Pergamon Press: New York, 1990, p 270-331.] The copper-catalyzed version of the reaction (CUAAC) has proven to be popular in many conditions, ranging from drug discovery to surface science, where rapid and reliable bond formation is required. Although much effort has been devoted to the toughening of gels by polymerization, as far as we are aware only a few polymerizable organogelators are readily accessible. [Tamaoki et al., Langmuir 2000, 16:7545-7547; de Loos et al., J. Am. Chem. Soc. 1997, 12675, 12676; Hanabusa et al., Chem. Lett. 1999, 767-768; Wang et al., Chem. Eur. J. 2002, 8:1954-1961; Aoki et al., Org. Lett. 2004, 6:4009-4012; Beginn et al., Chem. Eur. J. 2000, 6:2016-2023; Beginn et al., J. Polym. Sci.: Part A: Polym. Chem. 2000, 38:631-640; Masuda et al., Macromolecules 2000, 33:9233-9238] The ruthenium-catalyzed version of the reaction (RuAAC) is less extensively described [Zhang et al., J. Am. Chem. Soc. 2005, 127:15998-15999].

We describe here the introduction of azide and alkyne groups into organogelator compounds and the cross-linking of their noncovalent polyvalent networks by the CuAAC or the RuAAC reaction.

### BRIEF SUMMARY OF THE INVENTION

The present invention contemplates a modified gel, and a method for modifying the properties of a first gel. A contemplated method comprises the steps of a) admixing (i) a first gelator, (ii) an optionally present second gelator, and a (iii) a modulator molecule in the presence of a solvent for one, two or all of (i), (ii) and (iii) to form a reaction mixture. The first gelator, and second gelator when present, form a first gel with first properties under first predetermined conditions. The first gelator includes an alkyne or azide functionality and the modulator molecule contains the other of an azide or alkyne functionality that is not present in the first gelator and also includes a gel property-modifying entity. The alkyne functionality is preferably a terminal substituent when copper catalysis is used, but can be internal or terminal when Ru-catalysis is used. The reaction mixture is maintained in the presence of a catalyst for a time period and at a temperature sufficient for the alkyne and azide functionalities present to react to form a triazole bonded to the first gelator and to the gel property-modifying entity to form a second composition that forms a gel under second conditions that exhibits second properties. The reaction is preferably carried out in the presence of a copper(I) or ruthenium(II) catalyst and forms 1,2,3-triazole rings 1,4-bonded or 1,5-bonded between the two reactants. Where the acetylene is internal, 1,4,5-trisubstituted-1,2,3-triazole compounds are formed.

A contemplated second gel is a reaction product of the above method and contains a plurality of 1,2,3-triazole rings. The reaction product is formed by the reaction between (a) a first gelator that includes an alkyne or azide functionality and (b) a modulator molecule that includes a gel property-modifying entity linked to the other of a azide or alkyne functionality that is not present in the first gelator, and takes place in the presence of a catalyst. A second gelator can optionally be present also. The reaction forms a plurality of 1,2,3-triazole rings in the second gel by a catalyzed reaction of the alkyne and azide functionalities. Preferred catalysts are Cu(I) and Ru(II). A second gelator (c) can optionally be present also. The reaction forms a plurality of 1,2,3-triazole rings in the gel by a catalyzed reaction of the alkyne and azide functionalities. Preferred catalysts are Cu(I) and Ru(II). The second gel is (i) formed in a reaction mixture that is an admixture of (a), (b) and (c) when present, in the presence of a solvent for one, another, all or any combination of (a), (b) and (c), and the second gelator, when present, and (ii) exhibits properties different from those of a first gel formed from the admixture, in the absence of a catalyst, of the same amounts of (a), (b) and (c) present in the reaction mixture. The 1,2,3-triazole rings that are formed can be 1,4-disubstituted or 1,5-disubstituted.

A second gelator is preferably present, and the first gelator is present at about 90 to about 10 mole percent of the gelators present. The modulator molecule is typically present in an amount of about 2 to about 20 mole percent of the molar concentration of the first gelator

The gelator can form a hydrogel or an organogel. The different property of the gel of the second composition can be that it is less stable and more soluble in the solvent than the first gel. In other situations, the reaction stabilizes the gel surface with a shell of material that differs from the interior, whereas in another the gel of the second composition is more or less slippery.

### BRIEF DESCRIPTION OF THE DRAWINGS

In the drawings forming a part of this disclosure,

FIG. 1, in the upper portion, is a schematic representation of a hydrogen-bond pattern proposed for gelation of organic solvents by Compounds 1-3, and in the lower portion, a schematic representation of cross-linking of the gel by CUAAC reaction.

FIG. 2, in five panels 2A-2E, are a series of TEM images of the following gels, all made with 3 weight-% gelator: (A) Compound 1 in acetonitrile (MeCN); (B) Compound 2 in MeCN; (C) Compound 3 in MeCN; (D) Table 1, entry 14, Compounds 2+4+Cu^{I} in MeCN/2,6-lutidine; (E) Table 1, entry 15, Compounds 2+7+Cu^{I} in MeCN/2,6-lutidine in MeCN.

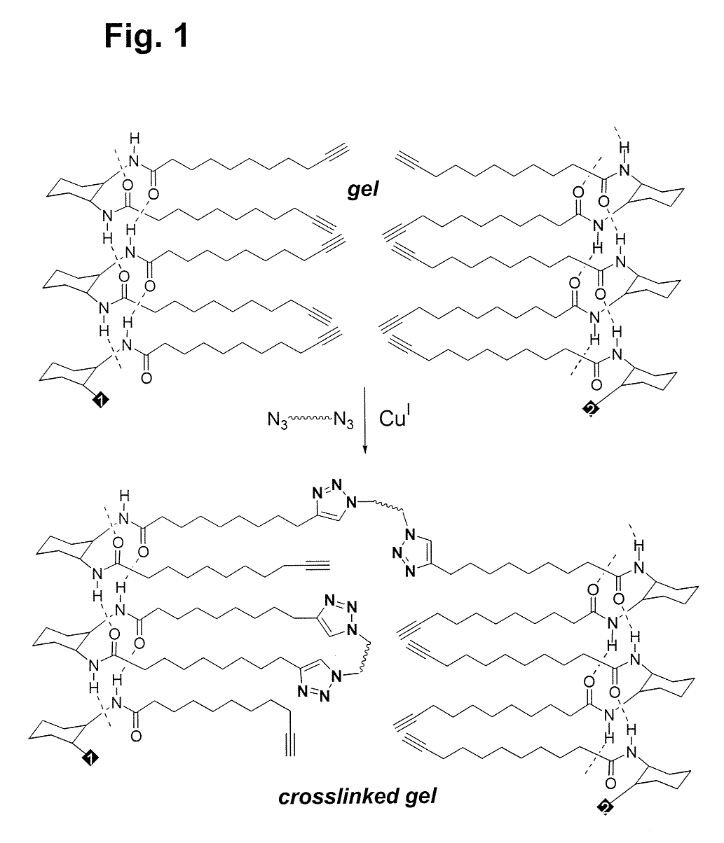

### DETAILED DESCRIPTION OF THE INVENTION

The present invention provides a method to tune or modulate the properties of a first gel that is preferably a thermoreversible gel by the introduction of a chemically innocuous group (azide or alkyne), with subsequent attachment of cross-linkers by a versatile catalytic process to form a second gel. Much of the previous work on polymerizable organogelators used a gelation process to set a template for a subsequent polymerization, turning non-covalent supramolecular assemblies into covalent polymers. These materials are no longer thermoreversible and tend to lose their well-ordered arrangements of hydrogen bonds.

In the method described here, a judicious level of click chemistry connectivity is used to modify the properties of gels (organogels or hydrogels), while retaining their overall structure, and usually also thermoreversibility, although thermoreversibility can also be removed as desired. The overall stability of azides and alkynes, along with the rate and specificity of the catalytic reaction that joins them, permits such a “cementing” process to take place with minimal disruption of the supramolecular ensemble. In those cases in which higher concentrations of cross-linkers are used to get more complete covalent networking, the resulting materials are rendered unable to form gels, presumably by predominant phase segregation.

A contemplated second gel is a reaction product of a method discussed hereinafter and contains a plurality of 1,2,3-triazole rings. The reaction product is formed by the reaction between (a) a first gelator that includes an alkyne or azide functionality, (b) a modulator molecule that includes a gel property-modifying entity linked to the other of an azide or alkyne functionality that is not present in the first gelator, and (c) an optional second gelator. The reaction forms a plurality of 1,2,3-triazole rings in the second gel by the catalyzed reaction of the alkyne and azide functionalities. The second gel is (i) formed from a reaction mixture that is an admixture of (a), (b), and (c) when present, in the presence of a catalyst and a solvent for one, another, all or any combination of (a), (b) and (c), and (ii) exhibits properties different from a first gel formed from the first gelator and modulator molecule in an unreacted state, as where (a) and (b) are present at the same concentrations in the solvent used for the reaction mixture, but in the absence of a catalyst.

The 1,2,3-triazole rings that are formed can be 1,4-disubstituted or 1,5-disubstituted, where a copper catalyst typically leads to formation of a 1,4-disubstituted-1,2,3-triazole, whereas a ruthenium catalyst typically induces formation of a 1,5-disubstituted-1,2,3-triazole. These are illustrated below.

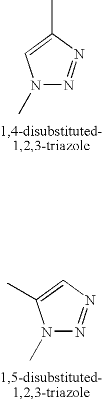

A contemplated second gel (1,2,3-triazole reaction product) contains an amount of the catalyst used; i.e., copper or ruthenium or both, that is greater than a background, impurity level, as can readily be measured by mass spectral or atomic absorption spectroscopy detection methods. Thus, an amount of residual catalyst material remains in the reaction product and that amount is greater than an amount that is found as a result of synthetic contamination, as where copper pipes are use to provide water for washing the product.

A catalyst is utilized in a catalytic amount as compared to a stoichiometric amount. The molar ratio of reactive “clickable” functionality to catalyst is typically about 1000:1 to about 25:1, and is more preferably about 500:1 to about 50:1. More preferably still, the ratio is about 250:1 to about 100:1.

Where copper is used as the catalyst, it is preferred that both the alkyne and azide groups be in terminal positions of whatever carbon-containing molecule to which either is bonded. It is to be understood that an azido group because of its monovalency (N═N═N—) is always a terminal functional group. On the other hand, an alkyne acetylenic functional group (—C≡C—) is bi-functional and can be present within a carbon chain, for example, or terminally. When ruthenium is used as catalyst, the acetylenic functional group can be internal.

Illustrative Cu(I) catalysts include CuI (copper iodide), Cu(C₂H₃O₂), Cu(CH₃CN)₄.PF₆, and CuOTf (copper triflate). The Ruthenium catalysts are preferably complexes with trigonal phosphorus or other liganding groups such as Ru(C₂H₃O₂)₂(PPh₃)₂, CpRuCl(PPh₃)₂, Cp*RuCl(PPh₃)₂, Cp*RuCl(NBD)₂, [Cp*RuCl₂]₂, and Cp*RuCl(COD), wherein “Cp”cyclopentadienyl, “Cp*”=pentamethylcyclopentadienyl, “PPh₃”=triphenylphosphoryl, “NBD”=norbornadiene, and “COD”=1,4-cyclooctadiene.

A reaction that forms a second gel can be carried out at any temperature and pressure at which click chemistry is carried out. Normally, the pressure is one atmosphere, but higher and lower pressures can be used if desired. Similarly, ambient room temperature is usually the lowest temperature at which the copper and ruthenium reactions are conducted, but those reactions can also be carried out at higher and lower temperatures. Temperatures of about 50° to about 90° C. are preferred for Ru-catalyzed reactions, whereas room temperature is preferred for Cu-catalyzed reactions. It is often convenient to raise the temperature of a mixture containing the first gelator and modulator molecules, followed by cooling to assist first gel formation, prior to the addition of the catalyst and the formation of the second gel.

A contemplated reaction product second gel can be in the form of a gelled liquid, a fiber or fiber mat. That product has modified properties relative to a starting gel that itself can be a gelled liquid, a fiber or fiber mat that does not contain the reaction product triazole rings. The reaction product gel can be a cross-linked material in which a first gelator reacts with a second gelator, which thereby acts as a modulator molecule, or first and second gelator molecules react with a modulator molecule, or a first gelator can react with a modulator molecule via the click chemistry to form the reaction product with modified properties.

A method of the invention contemplates a composition that preferably contains an admixture of two low molecular weight organic gelator (LMOG) molecule types that each can form a gel, and are referred to herein as a (i) first gelator and (ii) an optional second gelator. In less preferred practice, the composition only contains the first gelator. The first gelator includes one or the other of a click chemistry donor and acceptor functionality acetylenic or azido functionality, respectively. The admixed first gelator and second gelator form a gel with first properties under first predetermined conditions. The composition also contains (iii) an admixed modulator molecule that contains the other of a click chemistry acceptor or donor functionality that is not present in the first gelator; i.e., the other of an azide and alkyne functionality not present in the first gelator molecule. That functionality is bonded to a gel property-modifying entity. The composition includes a solvent for one, two or all of (i), (ii) and (iii), and the admixture of (i), (ii) when present, and (iii) forms a reaction mixture.

The first gelator can thus comprise the only gelator present in the composition. Preferably, the first gelator is present at about 90 to about 10 mole percent of the gelators present in the composition, and the second gelator is present at about 10 to about 90 mole percent of the gelators present in the composition. More preferably, the first gelator is present at about 70 to about 30 mole percent of the gelators present in the composition and the second gelator molecule is present at about 30 to about 70 mole percent of the gelators present in the composition. Most preferably, each of the first and the second gelator molecule types is present at about equal molar amounts of the gelators present in the composition. It is to be understood that a plurality of different chemical entities that perform the function of a first and a second gelator molecule can be present in a composition and that two molecule types are just recited for convenience of expression.

The gelator LMOG molecules are present in a contemplated method in a solvent-gelling amount. That amount is typically about 0.1 to about 50 weight percent of the solvent-containing composition, depending upon the gelator used. More preferably, the concentration is about 1 to about 10 weight percent, and more preferably still at about 2 to about 5 weight percent of the composition.

The third molecule type present in a contemplated composition, aside from the solvent, is a modulator molecule that contains the other of a click chemistry acceptor or donor functionality (preferably, an azide or alkyne) that is not present in the first gelator. That functionality is bonded to a gel property-modifying entity. Thus, the modulator molecule contains the other of the reactive pair of functionalities for carrying out a click chemical reaction that is not present in a first gelator molecule. Using the triazole-forming reaction used elsewhere herein as illustrative, if the first gelator molecule includes an alkyne functionality, the modulator molecule includes an azide functionality. On the other hand, if the first gelator contains an azide functionality, the modulator includes an alkyne group that can react with the azido group.

It is also to be understood that either or both of a first gelator and modulator molecules can contain more than a single click chemistry functionality, and frequently contains two, three or more of such functionalities. One or two such functionalities per molecule are preferred. Thus, a first gelator molecule can contain a single alkyne group or a single azide group, or two azide groups or two alkyne groups, or the like. Similarly, a modulator molecule can contain a single alkyne group per molecule or a single azide group per molecule. A modulator molecule containing two, three or more of one or the other of the azide and alkyne functionalities is also contemplated.

The modulator molecule also includes a gel property-modifying entity. That is, the click chemistry functionality is bonded to another chemical entity that modifies the properties of a gel formed by the gelator upon reaction of the modulator molecule with the first gelator. The gel property-modifying entity can be hydrophilic, hydrophobic, relatively large or small on a molecular level as is desired and exemplified hereinafter.

The modulator molecule is typically present in an amount of about 2 to about 20 mole percent of the molar concentration of the first gelator. More preferably, that amount is about 5 to about 15 mole percent.

Each of the first and second gelator molecules and the modulator molecules has a molecular weight (mass) of less than about 3000 Da. Preferably, each has a molecular weight of less than 1000 Da, and more preferably, the molecular weight of each of those molecules is less than about 500 Da.

Substantially any solvent can be used in a contemplated method so long as it dissolves at least one of the three recited ingredients, and preferably two of the three recited ingredients, and most preferably all three recited ingredients. In addition to water used with hydrogels, illustrative solvents include hexane, methanol, ethanol, iso-propanol, ethyl acetate, acetone, acetonitrile, pyridine, 1,4-dioxane, benzene, toluene, chlorobenzene, nitrobenzene, N,N-dimethyl formamide, N,N-dimethyl acetamide, dimethyl sulfoxide, chloroform, dichloromethane, carbon tetrachloride and silicone oil. Mixtures of several of these solvents can also be used. Use of some of the above solvents is illustrated in Table 3 hereinafter.

Applications of the present invention derive from the general scheme of modifying gelator molecules by click chemistry [illustratively and usually the azide-alkyne cycloaddition (AAC) reaction, and most often the copper-catalyzed version (CuAAC)] or ruthenium-catalyzed version (RuACC), either after the gel is established, or before gelation is permitted to occur. This aspect if click chemistry is utilized for several reasons including the facts that: (1) azide and alkyne groups are easy to introduce by standard synthetic chemistry methods, (2) azide and alkyne groups are sufficiently small and chemically innocuous that they induce minimal changes in the properties of the gelators or gels prior to reaction, (3) attached azide and alkyne groups can be reliably addressed by the AAC reaction to make covalent connections between the gelators and a wide possible variety of chemical entities, and (4) the surfaces of gels can be differentiated from their interiors. The CUAAC or RuAAC process can be regarded as a universal connector for altering materials properties as described above.

Thus, when a gelled material containing azide or alkyne groups is exposed to a copper or ruthenium catalyst and the other, complementary reacting group, the most physically accessible portions of the gel react first. The outer surface of the gel can be selectively modified relative to the interior because diffusion through the gel is usually quite slow (on the order of an hour for complete penetration of solutions through a centimeter-thick gel).

The phenomenon of tertiary phase separation (or, domain self-assembly) can be controlled by attaching groups by the AAC reaction. Organo- and hydrogels exhibit primary and secondary phase separation in order to form gels: the gelator molecules associate with each other by virtue of aggregation of hydrophobic or hydrophilic portions of the structures (primary), and then self-assemble into nanostructures such as fibers (secondary).

Normally, gels have little phase aggregation beyond this; in other words, fibers are dispersed randomly, having been swollen by the trapped solvent. By introducing other groups to the gelator structure after the gel has formed, another level of ordering can be imposed by attaching units that self-associate to the surfaces of the nanostructures that make up the gels. This can affect the overall chemical, physical, and mechanical properties of the gels as in the following examples.

One aspect of the invention contemplates making gel materials less stable and more soluble. Thus, gelators self assemble in order to sequester hydrophobic groups away from water (hydrogels), or hydrophilic groups away from organic solvent (organogels). The decomposition of a gel by dissolution in the solvent medium can therefore be accelerated by grafting on groups that move this balance away from self-assembly and toward interaction with solvent. For example, clicking a mildly hydrophilic group onto the hydrophobic domain of an organogelator can have the desired destabilizing effect. An illustrative mildly hydrophilic group is an azidotriglyme compound of the formula HO—(CH₂CH₂—O)₂—CH₂CH₂—N₃.

Another method for stabilizing gels that differs from cross-linking them through their entire depth is to stabilize the surface with a shell of material that differs from the interior.

Another aspect of the invention contemplates making gel materials more or less slippery. Here, the surface of a gel can be addressed with chemical groups that promote or inhibit adhesion to a desired surface. Thus, a high density of triazole units makes a material sticky toward metals; hydrophobic groups make the surface sticky toward plastics; poly(ethylene glycol) (PEG) makes many surfaces slippery. Providing a plurality of PEG molecules on a reaction product gel surface can cause the surface to resist adsorption of proteins and cells. On the other hand, providing a gel surface with a plurality of cationic groups can provide an anti-bacterial effect and can cause the gel to become sticky toward human skin and hair and anionic dyes.

In another surface modulation embodiment, a clickable reagent such as 3-azidopropylamine (Compound 12) or 10-undecynoic acid that are discussed elsewhere herein and be amide-bonded to the carboxy- or amino-terminus, respectively, of a peptide or protein and a dye or radiolabel linked to the gel surface via a click reaction with a corresponding alkyne or azido compound and appropriate catalyst to form the 1,2,3-triazole ring linking groups.

Yet another gel property that can be modulated by the contemplated click chemistry is a bulk mechanical property, including internal friction. Thus, the internal friction of a gel can be changed by introducing a modest and controlled level of internal phase separation, as illustrated here. The properties of the derivatized gel material are determined by the properties of the attached groups and the density of their installation.

In a still further aspect of the invention contemplates nucleating the deposition of a “filler material”. Organo- and hydrogels have been used to template the construction of materials by polymerization inside the channels of the gel, mostly for the construction of silicon and titanium oxide materials by sol-gel polymerization. [Murata et al., J. Am. Chem. Soc., 1994 116:6664-6676; Gill et al., J. Am. Chem. Soc., 1998 120:8587-8598; Corma et al., J. Chem. Soc., Chem. Commun., 1998 1899-1900; DePaul et al., J. Am. Chem. Soc., 1999 121:5727-5736; Asefa et al., Angew. Chem. Int. Ed., 2000 39:1808-1811; Jung et al., Angew. Chem. Int. Ed., 2000 39:1862-1865; Jung et al., J. Am. Chem. Soc., 2000 122:5008-5009; Kobayashi et al., Bull. Chem. Soc. Jpn., 2000 73:1913-1917; Jung et al., Chem. Eur. J., 2000 6:4552-4557; Jung et al., Angew. Chem. Int. Ed., 2000 39:1862-1865; Tamaru et al., Angew. Chem. Int. Ed., 2002 41:853-857; George et al., Chem. Eur. J., 2005 11:3217-3227; Kishida et al., J. Am. Chem. Soc., 2005 127:7298-7299.] The use of click chemistry can improve upon the methods used by introducing a much wider array of groups that can direct such polymerization reactions in hydrogels and organogels themselves. In this application, the gel acts as a “template” for the formation of a different material such as a polymer, and can then be dissolved away or retained if it provides desirable properties.

The kinds of secondary polymerization reactions that can be used include: atom-transfer radical polymerization, ring-opening metathesis polymerization, cationic polymerization as with oxazoline monomers and related processes, anionic polymerization, radical polymerization, and the formation of mineralized materials by the use of peptides that nucleate the deposition of minerals from solutions of metal ions.

The method of introducing the active units by click chemistry after gel formation is superior to making gels with molecules already containing the active units, because such units usually inhibit the formation of gels when present initially. The click chemistry methodology permits the gels to be established with innocuous azide and alkyne groups; once the superstructures are formed, they can be modified with a much greater array of functional molecules.

The illustrative low molecular weight organogelators of this study are based on the undecylamide of trans-1,2-diaminocyclohexane, Compound 1, initially reported by Hanabusa and co-workers [Hanabusa et al., Angew. Chem. Int. Ed. 1996, 35:1949-1951]. Molecular modeling studies from this group suggest that the two equatorial amide-NH and amide-CO can align antiparallel to each other and perpendicular to the cyclohexyl ring, forming an extended structure stabilized by two hydrogen bonds between each molecule. Because azides and alkynes are small and nonprotic, their placement at the end of the hydrophobic chains of the gelator was not expected to disrupt the gelation process too much. Subsequent copper-mediated reaction of these groups can then serve to alter, and to stabilize or otherwise modify, the resulting materials.

The “clickable” organogelators Compounds 2 and 3 were prepared as analogues of Compound 1, in one or two steps from commercially available reagents. 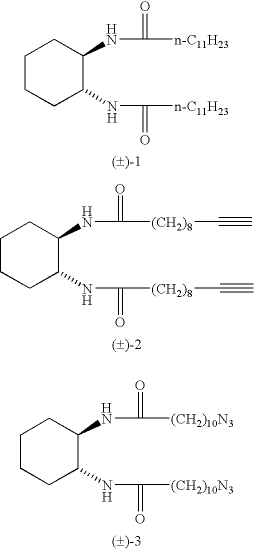
A study of the properties of Compounds 1-3 showed that all three compounds made stable organogels, but that Compound 1 was the most efficient, forming gels at lower concentrations than the others. Acetonitrile was found to be gelled by modest concentrations of Compounds 2 and 3 (20 and 15 mg/mL, respectively), forming organogels that were stable for several months at room temperature.

Because acetonitrile is also a good solvent for the CuAAC reaction in the presence of bases such as 2,6-lutidine, this solvent was used for further studies. Note also that, for purposes of illustration, we used the racemic form of the chiral gelators; enantiopure materials usually make more stable gels. Structural formulas of further useful LMOG cross-linkers (having two groups reactive in a CuAAC reaction) and capping compounds (having a single reactive functionality) are illustrated below as Compounds 4-10.

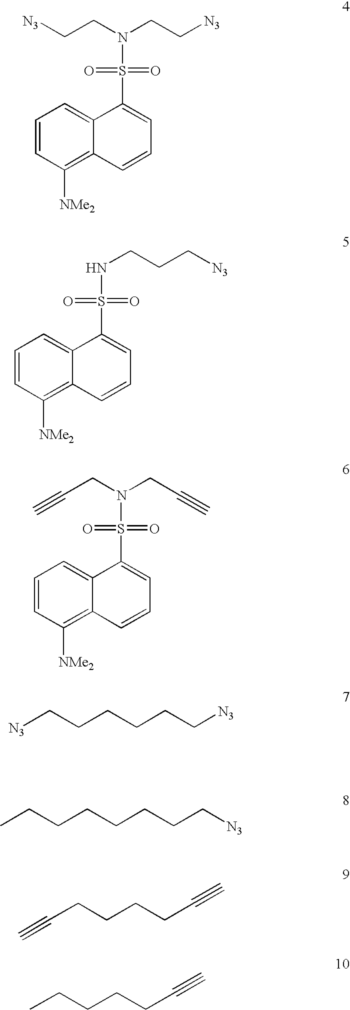

Two methods were used to induce the formation of triazoles, and both were performed under nitrogen to eliminate the competitive oxidation of Cu^{I} as a complicating factor. In the first, designated method A, all of the reaction components [gelator, cross-linker, catalytic cuprous iodide (CuI)] were mixed in a combination of acetonitrile and 2,6-lutidine (MeCN/lutidine), heated to achieve complete dissolution (10-30 seconds), and then permitted to stand and cool to room temperature. In method B, the gelator was heated in MeCN/lutidine to dissolve, cooled to room temperature and permitted to stand for 8 hours, and then a solution of CuI was layered on top of the gel and permitted to diffuse into the material.

By following reactions of Compound 2 with monoazide Compounds 5 or 8 (and Compound 3 with monoalkyne Compound 10) by GC-MS, it was established that in the gelled state the CUAAC reaction required 1-4 days to reach completion, depending on the experimental method used, and thus gels were permitted to stand for 1 week. After this time, the gels were exposed to air and heated and cooled to room temperature to re-form the gel; in this way, Cu^{I} is sure to be oxidized and the click reaction stopped. MALDI-MS analysis of the cross-linked gels showed the presence of triazole adducts.

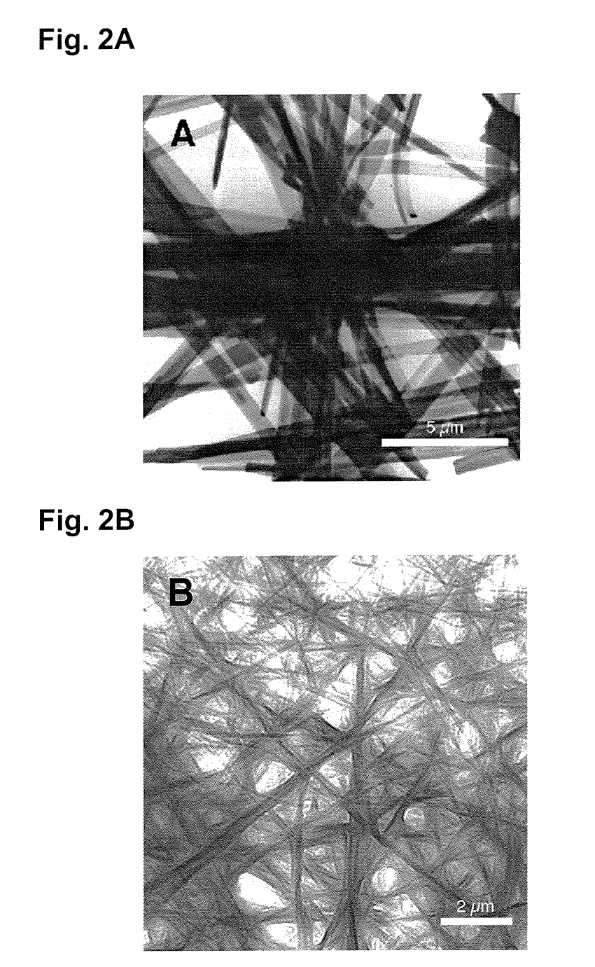

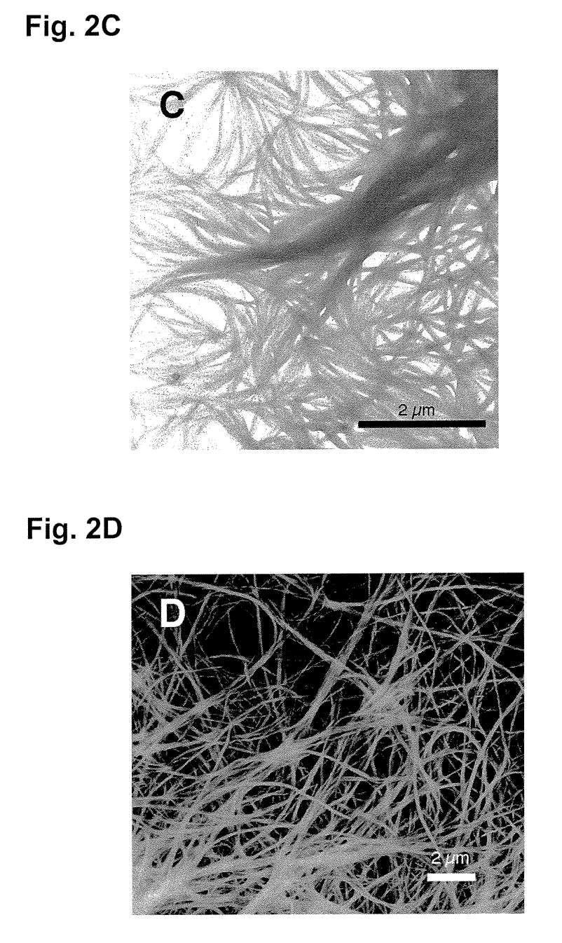

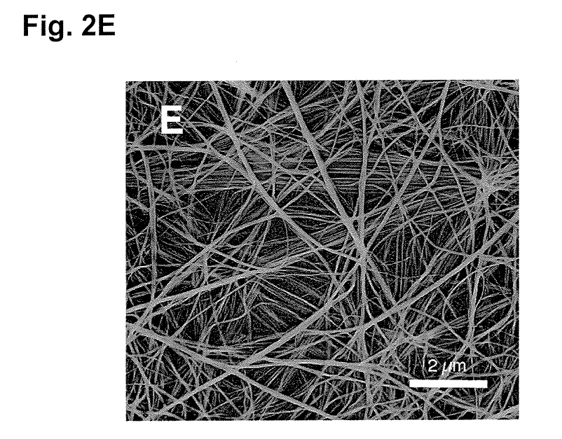

In MeCN containing 5% 2,6-lutidine, Compounds 1, 2, and 3 did not form gels at room temperature at concentrations of 3 weight %. However, when CuI and the cross-linkers (modulator molecule) were incorporated in method A at a gelator:cross-linker ratio of 10:1, a remarkable change in the low viscosity mixture took place and stable organogels were formed upon cooling to room temperature (Table 1, entries 14-17; FIG. 2F). The gelator:cross-linker ratio refers to the ratio of reactive groups (azides and alkynes) in the two species. In most cases, both are divalent, and so the ratio also refers to the overall molar ratio. At higher concentrations of cross-linker than 10:1 (gelator:cross-linker), phase separation of the resulting material was consistently evident. When lesser amounts of cross-linkers were used, the strength of the resulting gels diminished in proportion to the cross-linker concentration.

Interestingly, the equimolar combination of dialkyne gelator Compound 2 with diazide gelator Compound 3 also gave a room-temperature gel in the presence of Cu^{I}, but with a gel-to-sol transition temperature (T_{gel}) significantly lower than the others (entry 18). The other entries in Table 1 show that room temperature gelation under these conditions was dependent upon the simultaneous presence of active Cu catalyst and the appropriate bifunctional cross-linker. Omission of Cu (entry 14-17 vs. 4-7) and the use of monofunctional “caps” instead of cross-linkers (entries 11-13) resulted in no gelation, even though in the latter cases the complete formation of triazoles was observed. The use of catalytically inactive Cu^{II} sulfate under otherwise identical conditions likewise gave solutions instead of gels (entries 19 and 20), as did the use of mismatched cross-linkers (entries 21 and 22). Therefore, gelation was not assisted by any interaction of Cu ions with the starting materials (such as by the formation of Cu acetylide species).

To test the potential role of copper binding in stabilizing the gelled materials, the solvent was removed under vacuum from equilibrated gels formed in entries 14, 15, and 17, and the residue was washed extensively with aqueous 0.1 M EDTA solution to remove the metal. [Díaz et al., J. Polym. Sci.: Part A: Polym. Chem., 2004, 42:4392-4403] The resulting material mixture was filtered, dried under high vacuum, and was found to readily form stable organogels at room temperature that were very similar (T_{gel} approximately 5° C. lower than the original sample, data not shown) to the original materials. Thus, Cu-triazole interactions are not likely to be important to the stabilization of gels by CuAAC reaction.

TABLE 1 ^{a}

| Entry | Components | Phase ^{b} | T_{gel} ^{c} |
|---|---|---|---|
| 1 | 1 | S | — |
| 2 | 2 | S | — |
| 3 | 3 | S | — |
| 4 | 2 + 4 | S | — |
| 5 | 2 + 7 | S | — |
| 6 | 3 + 6 | S | — |
| 7 | 3 + 9 | S | — |
| 8 | 2 + 3 | S | — |
| 9 | 3 + Cu^{I} | S | — |
| 10 | 2 + Cu^{I} | S | — |
| 11 | 2 + 5 + Cu^{I} | S | — |
| 12 | 2 + 8 + Cu^{I} | S | — |
| 13 | 3 + 10 + Cu^{I} | S | — |
| 14 | 2 + 4 + Cu^{I} | G | 86° C. |
| 15 | 2 + 7 + Cu^{I} | G | 83° C. |
| 16 | 3 + 6 + Cu^{I} | G | nd |
| 17 | 3 + 9 + Cu^{I} | G | 91° C. |
| 18 | 2 + 3 + Cu^{I} | G | 47° C. |
| 19 | 2 + 7 + Cu^{II} | S | — |
| 20 | 3 + 9 + Cu^{II} | S | — |
| 21 | 2 + 9 + Cu^{I} | S | — |
| 22 | 3 + 7 + Cu^{I} | S | — |
| ^{a} Each reaction was performed in an inert-atmosphere dry box with degassed CH₃CN (1.9 mL) and 2,6-lutidine (0.1 mL), employing a gelator concentration of 3 weight % and a gelator:cross-linker ratio of 10:1. CuI was introduced from a 0.1 M stock solution in | | | |
| # CH₃CN, and method A was employed as described elsewhere herein. The state of each sample was determined by visual inspection after permitting the sample to stand overnight (about 18 hours) at room temperature, although gelation in each successful case occurred within five minutes. | | | |

^{b} Abbreviations: S = solution at room temperature; G = stable gel at room temperature; nd = not determined. All samples designated “S” reversibly formed gels when cooled to temperatures below 10° C..
^{c} Determined by the inverse flow method.

The binary cross-linked gels (Table 1, entries 14, 15, 17) were found to be stable toward heating through the boiling point of acetonitrile, in spite of losing some solvent between 60 and 90° C. In appearance, they were significantly more turbid than the gels made from Compounds 1, 2, or 3 alone, but did exhibit fully reversible gel-to-sol phase transitions upon repeated heating and cooling.

FTIR spectroscopy shows the expected evidence for amide H-bond participation in the gelled state of both non-cross-linked and cross-linked gels. Hydrogen bonding in the gel should shift both carbonyl and NH resonances to lower energy with respect to the spectra recorded in the solid state, and such shifts were uniformly observed: from 1640-1654 to 1630-1638 cm⁻¹ for amide I bands; from 1545-1555 to 1539-1541 cm⁻¹ for amide II bands; and from 3301-3330 to 3280-3290 cm⁻¹ for NH stretching bands, respectively. In several cases, the residue obtained after evaporation of solvent from the gels was analyzed by ¹H NMR and was found to exhibit the characteristic C—H resonance for 1,4-aliphatic triazoles at 7.21-7.24 ppm.

Gel morphologies were investigated by transmission electron microscopy (TEM). Gels made from the individual gelators in MeCN (without 2,6-lutidine) showed differences consistent with the more efficient gelation properties of Compound 1. The structure of gelled Compound 1 was characterized by large, rod-like filaments, whereas Compound 2 and Compound 3 both showed smaller fibers (FIG. 2). Gels made with combinations of agents (entries 4-8) in MeCN were very similar to Compound 2 and Compound 3 alone (not shown). Cross-linked gels made with Compound 2 or Compound 3 in MeCN/2,6-lutidine (FIG. 2D, 2E) showed morphologies similar to non-cross-linked analogues. Thus, the significantly greater stabilities of the former do not appear to be the result of a gross change in structure.

Gels made from Compound 2 or Compound 3 were found to be strengthened by the incorporation of Compound 1 into the gelator mixture. Thus, when equimolar amounts of Compounds 1 and 2 (or 3) were used, gels in 19:1 MeCN:2,6-lutidine were stable at room temperature prior to CUAAC cross-linking. Table 2 summarizes a series of studies performed with such materials.

TABLE 2^{a}

| | | Obser- | Obser- | Obser- |
|---|---|---|---|---|
| | Components | vations^{b} | vations^{b} | vations^{b} |
| Entry | (Compound) | Method A | Method B | Method C |
| 1 | 1 | PG | — | — |
| 2 | 1 + 2 | G (65° C.) | — | — |
| 3 | 1 + 3 | G (58° C.) | — | — |
| 4 | 1 + 2 + 4 | G (62° C.) | — | — |
| 5 | 1 + 2 + 7 | G (65° C.) | — | — |
| 6 | 1 + 3 + 6 | G (66° C.) | — | — |
| 7 | 1 + 3 + 9 | G (68° C.) | — | — |
| 8 | 1 + 2 + 3 | G (63° C.) | — | — |
| 9 | 1 + 2 + Cu^{I} | G (68° C.) | — | — |
| 10 | 1 + 3 + Cu^{I} | G (61° C.) | — | — |
| 11 | 1 + 2 + 5 + Cu^{I} | G (67° C.) | — | — |
| 12 | 1 + 2 + 4 + Cu^{I} | G (91° C.) | HG | FG |
| 13 | 1 + 2 + 7 + Cu^{I} | G (94° C.) | G (93° C.) | HG |
| 14 | 1 + 3 + 6 + Cu^{I} | PG | HG | FG |
| 15 | 1 + 3 + 9 + Cu^{I} | G (101° C.) | G (96° C.) | FG |
| 16 | 1 + 2 + 3 + Cu^{I} | G (69° C.) | G (68° C.) | HG |
| 17 | 1 + 2 + Cu^{II} | G (73° C.) | G | HG |
| 18 | 1 + 2 + 6 + Cu^{II} | G (68° C.) | G | FG |
| 19 | 1 + 2 + 9 + Cu^{I} | G (70° C.) | G (69° C.) | FG |
| 20 | 1 + 2 + 6 | G (60° C.) | — | — |
| 21 | 1 + 2 + 9 | G | — | — |
| 22 | 1 + 2 + 9 + Cu^{I} | PG | PG | PG |
| ^{a}Each reaction was performed in an inert-atmosphere dry box with degassed CH₃CN (0.95 mL) and 2,6-lutidine (0.05 mL), employing equimolar amounts of Compound 1 and Compound 2 or Compound 1 and Compound 3, a total gelator concentration of 3 wt %, and a gelator:cross-linker | | | | |
| # ratio of 10:1. CuI was introduced from a 0.1 M stock solution in CH₃CN. Methods A and B are described elsewhere herein; Method C resembles Method A, except that all of the reaction components were maintained at 60° C. for 8 hours before being permitted to cool to room temperature. | | | | |

^{b}Abbreviations: G = stable gel; LG = loose gel upon mechanical disruption (shaking); HG = heterogeneous stable gel; PG = gel that showed precipitated material after a few days; FG = stable gel with visible macroscopic phase separation. T_{gel} values for some samples are given in parenthesis.

It was again found that the introduction of Cu^{I} into samples containing both diazide and dialkyne molecules gave gels with markedly higher transition temperatures, indicative of greater stability. Little or no increase in T_{gel} was observed when only azide or alkyne, or a monofunctional reaction partner, was present (for example, entry 2 vs. 9, 11, 19, 22; entry 3 vs. 10). Omission of Cu^{I} or the use of Cu^{II} instead of Cu^{I} was similarly ineffective (entry 2 vs. 4, 5, 17, 18).

On the other hand, when all the proper components of CuAAC cross-linking were available, T_{gel} values increased by approximately 30° C. (entry 2 vs. entries 12, 13; entry 3 vs. entry 15). The results were very similar when the click reaction was permitted to proceed for only a short time in solution at higher temperature (and therefore mostly in the gelled state at room temperature) or exclusively in the gelled state by layering on Cu^{I} after gel formation (Methods A and B).

Interestingly, however, when the reaction components were permitted to react for 8 hours at elevated temperature before cooling to form the gel (Method C, Table 2), macroscopic phase separation was evident in almost every case. This suggests that the extent of CuAAC reaction in the last method is greater than the first two, and that the formation of too high a concentration of triazoles gives rise to self-aggregation phenomena.

1. Experimental Section:

a) Compound Syntheses and Characterization:

¹H and ¹³C NMR spectra were obtained on a Bruker DRX-500 instrument. Mass spectrometry was performed with an Agilent 5973N GC/MS, or 1100 LC/MS spectrometer eluting with 90:10 CH₃OH:H₂O (polarity/scan: positive). Unless otherwise indicated, the polarity/scan type used for ESI-MS was positive. IR spectra were obtained on a MIDAC FT-IR instrument using a horizontal attenuated total reflectance (HATR) accessory (Pike Instruments), or on an AVATAR Thermo Nicolet instrument using KBr pellets at room temperature. Melting points were measured in a Thomas Hoover capillary melting point apparatus and are uncorrected. Chromatographic purification was conducted using 40-63 μm silica gel obtained from SiliCycle Inc. Quebec City, Canada. TLC analysis was facilitated by the use of the following stains in addition to UV light with fluorescent-indicating plates (silica gel on aluminum, Sigma): phosphomolybdic acid, vanillin/EtOH, anisaldehyde/EtOH, or KMnO₄/H₂O. THF, acetonitrile, diethyl ether, and toluene were dried by passage through activated alumina columns [Alaimo et al., J. Chem. Educ., 2001, 78:64]; acetone was dried by refluxing over CaH₂; dry DMSO and DMF were of p.a. grade and purchased from Aldrich. Reactions requiring anhydrous conditions were performed under nitrogen. Elemental analyses were performed by Midwest Microlabs, Inc. MALDI-TOF and high-resolution mass spectral analyses were performed by the Scripps Center for Mass Spectrometry. Commercially available reagents were used without further purification.

b) Transmission Electron Microscopy (TEM):

10 μL of the polymeric gel suspension was permitted to adsorb for 3 minutes onto copper grids (300 mesh) coated with both Formvar® (polyvinyl formal resin now manufactured under the name Vinylec® from Structure Probe, Inc./SPI Supplies of West Chester, Pa.) and silicon monoxide. The relatively large size of the polymer pieces made negative staining unnecessary for visualization. Samples were observed with a Phillips CM120 transmission electron microscope operating at a voltage of 100 kV.

c) Gelation Studies:

A weighed amount of the components of each study and the appropriate solvent system were placed in a screw-capped vial (4.7 cm length and 1.2 cm diameter) in an inert-atmosphere glove box and heated with a heat-gun until the solid was completely dissolved (isotropic solution). The resulting clear solution was cooled down to room temperature (Method A, Tables 1 and 2, above) and the gelation was monitored visually by turning the test vial upside-down. The material was classified as “gel” if it did not exhibit gravitational flow. In other cases, the above CuI-containing solution was kept at 50° C. on a heating plate during 8 hours to avoid the gel formation, after which time the solution was permitted to cool to room temperature with the subsequent formation of the gel (Method C, Table 2, above). In other studies, a few drops from a concentrated solution of CuI were added carefully on the top of the gel, permitting the incorporation of the metal to the 3-dimensional-network by a slow diffusion phenomenon (Method B, Table 2, above).

Gelation temperatures were determined by the “inverse flow method” [Alaimo et al., J. Chem. Educ. 2001, 78:64]: A sealed vial containing the gel was immersed inversely in a thermostat-controlled oil bath. The temperature of the bath was raised at rate of about 2° C. min⁻¹. Here, the T_{gel} was defined as the temperature at which the gel moved on tilting of the vial. The experimental error of T_{gel} was less than 1° C.

d) Rheology of Organogels:

Oscillatory rheology studies were performed to measure the viscoelastic nature of the materials. Different batches of samples were prepared and the Theological studies repeated for consistency. To obtain equilibrium, the samples were permitted to stay at room temperature for at least 4 days.

Three different assays were carried out for each sample, using 1 mL of total volume for one set of assays:

1. Dynamic Time Sweep study: plot of storage modulus (G′, elastic component) and loss modulus (G″, viscous component) with time. In this study, the strain (0.02%) and the frequency (6 rad/sec) were kept constant. The magnitude of G′ is an indication of the extent of cross-linking leading to material rigidity. The material is considered a gel if G′>G″.

2. Dynamic Frequency Sweep Study: plot of G′ and G″ with frequency (0.1 to 100 rad/sec). This was done to make sure that the material responds within the linear viscoelastic regime (LVR) (during the dynamic time sweep study) with the frequency used (6 rad/sec in this case) to interrogate the system.

3. Dynamic Strain Sweep Study: plot of G′ and G″ with strain (from 0.01 to 100%). This was done to assure that the material responds within the linear viscoelastic regime (LVR) (during the dynamic time sweep experiment) with the strain (0.02% in this case) used to interrogate the system. At higher strains, the material tends to fracture, which is an indication of how brittle the material is.

2. Compound Syntheses.

The syntheses of the compounds were carried out under nitrogen atmosphere by using a vacuum line and Schlenk techniques. Compounds 9 (1,7-octadiyne) and 10 (1-heptyne) are commercially available. The following compounds are known and were readily prepared by the reported procedure displaying identical spectroscopic data: Compound 1, [Hanabusa et al., Angew. Chem. Int. Ed., 1996, 35:1949-1951] Compound 4 [Díaz et al., J. Polym. Sci. Part A: Polym. Chem., 2004, 42:4394^{˜}4403], Compound 8 [Alvarez et al., Synthesis, 1997, 413-414] and 3-azidopropylamine (Compound 12; Díaz et al., J. Polym. Sci. Part A: Polym. Chem., 2004, 42:4394-4403). The rest of the starting materials are also commercially available (Aldrich, Acros or Fluka).

Stock solutions of the cross-linkers (1.0 M in acetonitrile) were prepared in an inert-atmosphere glove box and keep there for further experiments. The syntheses of the low-molecular-weight organogelators (LMOGs) and cross-linkers are summarized in Scheme S1; the purity of products was verified with NMR, thin-layer chromatography and elemental analyses. Synthetic procedures and characterization data for new compounds follow.

### Compound 2: N-[(1,2-trans)-2-(10-Undecynoyl-amino)cyclohexyl]-10-undecynamide

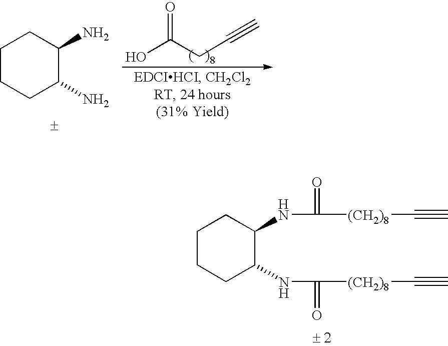

To a suspension of 10-undecynoic acid (5.0 g, 26.1 mmol) in dry CH₂Cl₂ (60 mL) was added N-(3-dimethylaminopropyl)-N′-ethylcarbodiimide hydrochloride (EDCl.HCl) (6.1 g, 31.3 mmol) in one portion at room temperature (RT). The mixture was stirred for 30 minutes, after which time (±)-trans-1,2-diaminocyclohexane (1.6 g, 14.4 mmol) was added drop-wise. After stirring 24 hours at RT and then 2 hours under reflux, the mixture was cooled at RT, and the solvent evaporated under reduced pressure. The residue was purified by flash chromatography in silica gel (elutant, 40% EtOAc-Hexanes) to afford Compound 2 as white solid (1.98 g, 31% yield). R_{f}=0.4 (50% EtOAc-hexanes); mp: 103±1° C.; ¹H-NMR (CDCl₃) δ 1.20-1.33 (m, 16H), 1.34-1.42 (m, 4H), 1.46-1.54 (m, 4H), 1.54-1.61 (m, 4H), 1.74 (br d, J=7.0 Hz, 2H), 1.94 (t, J=2.6 Hz, 2H), 2.02 (br d, J=12.5 Hz, 2H), 2.07-2.14 (m, 4H), 2.17 (dt, J=7, 2.6 Hz, 4H), 3.64 (br s, 2H), 6.01 (br s, 2H); ¹³C-NMR (CDCl₃) δ 18.3, 24.7, 25.7, 28.4, 28.6, 28.9, 29.1, 29.2, 32.2, 36.8, 53.5, 68.1, 84.6, 173.8; IR (KBr, cm⁻¹) 3300, 3082, 2931, 2117, 1643, 1546, 962, 630; MS m/z (relative intensity) 465 (M.Na) (11), 444 (M.2) (30), 443 (M.1) (100). Anal. Calcd for C₂₈H₄₆N₂O₂.⅓ H₂O: C, 74.95; H, 10.48; N, 6.24. Found: C, 74.87; H, 10.26; N, 6.07.

### Compound 3: 11-Azido-N-{(1,2-trans)-2-[(11-azidoundecanoyl)amino]cyclohexyl}undecanamide

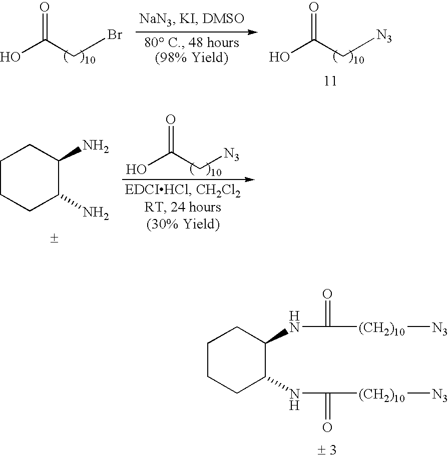

To a solution of 11-bromoundecanoic acid (10.0 g, 37.3 mmol) in DMSO (70 mL) was added NaN₃ (12.3 g, 186.7 mmol) and KI (3.1 g, 18.7 mmol) at room temperature (RT). The mixture was heated at 80° C. for 48 hours, after which time H₂O (50 mL) was added, stirred for additional 30 minutes, and the mixture was extracted with EtOAc (3×50 mL). The combined organic phases were washed with brine (3×50 mL), dried (MgSO₄) , filtered, and the solvent evaporated under vacuum to afford Compound 11 (8.3 g, 98% yield) as pale yellow oil, which crystallized at low temperature. ¹H-NMR (CDCl₃) δ 1.29-1.39 (m, 12H) 1.57-1.64 (m, 4H), 2.35 (t, J 7.4, 2H), 3.26 (t, J=7.4, 2H); ¹³C-NMR (CDCl₃) δ 24.7, 25.7, 26.6, 28.8, 29.1, 29.3, 32.3, 36.8, 51.4, 53.6, 173.8; IR (thin film, cm⁻¹) 2910, 2856, 2092, 1715, 1467, 1284, 933; MS m/z (relative intensity) (polarity/scan type: negative) 226 (M^{˜}1) (100). Anal. Calcd for C₁₁H₂₁N₃O₂: C, 58.12; H, 9.31; N, 18.49. Found: C, 58.08; H, 9.33; N, 18.22.

To a solution of 11-azidoundecanoic acid (5.9 g, 26.1 mmol) in dry CH₂Cl₂ (60 mL) was added N-(3-dimethylaminopropyl)-N′-ethylcarbodiimide hydrochloride (EDCI.HCl) (6.1 g, 31.3 mmol) in one portion at RT. The mixture was stirred for 30 minutes, after which time (±)-trans-1,2-diaminocyclohexane (1.6 g, 14.4 mmol) was added dropwise. After stirring 24 hours at RT and then 2 hours under reflux, the mixture was cooled at RT, and the solvent evaporated under reduced pressure. The residue was purified by flash chromatography in silica gel (elutant, 40% EtOAc-Hexanes) to afford Compound 3 as white solid (2.3 g, 30% yield). R_{f}=0.5 (50% EtOAc-hexanes); mp: 125±1° C.; ¹H-NMR (CDCl₃) δ 1.20-1.36 (m, 27H), 1.58 (q, J=7.4, 8H), 1.71 (br s, 1H), 1.74 (br d, J=8.4, 2H), 2.02 (br d, J=12.5, 2H), 2.11 (dd, J=13.2, 7.3, 4H), 3.25 (t, J=7.0, 4H) , 3.64 (t, J=8.1, 2H), 5.95 (br s, 2H); ¹³C-NMR (CDCl₃) δ 24.7, 25.7, 26.6, 28.8, 29.1, 29.2, 29.25, 29.3, 29.4, 32.3, 36.8, 51.4, 53.6, 173.8; IR (KBr, cm⁻¹) 3300, 3082, 2923, 2512, 2100, 1640, 1546, 963, 721; MS m/z (relative intensity) 555 (M.Na) (8), 534 (M.2) (35), 533 (M.1) (100). Anal. Calcd for C₂₈H₅₂N₈O₂: C, 63.12; H, 9.84; N, 21.03. Found: C, 63.49; H, 9.53; N, 20.95.

### Compound 5: N-(3-Azidopropyl)-5-(dimethylamino)-1-naphthalenesulfonamide

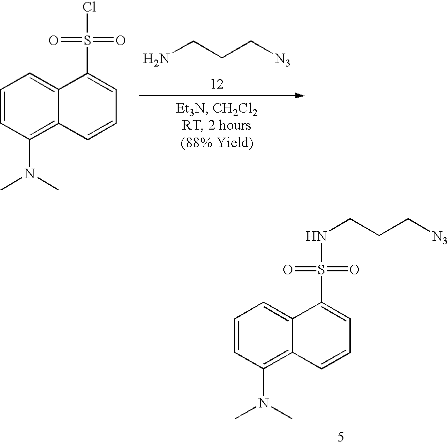

To a solution of dansyl chloride (5.0 g, 18.5 mmol) and Et₃N (2.0 g, 19.4 mmol) in dry CH₂Cl₂ (90 mL) was added 3-azidopropylamine (Diaz et al., J. Polym. Sci. Part A: Polym. Chem. 2004, 42:4394-4403; 14.6 mL, 1.4M in toluene, 20.4 mmol; Compound 12) at RT. The mixture was stirred for 2 hours, after which time TLC analysis showed no remaining starting material. The solution was diluted with CH₂Cl₂ (100 mL) and washed subsequently with 5% HCl aqueous solution (3×50 mL), NaHCO₃ saturated aqueous solution (3×50 mL), and brine (3×50 mL). The combined organic phases were dried (MgSO₄), filtered, and the solvent evaporated under vacuum. The residue was purified by flash chromatography in silica gel (elutant, 30% EtOAc-Hexanes) to afford Compound 5 (5.4 g, 88% yield) as yellow-orange oil. R_{f}=0.25 (20% EtOAc-hexanes); ¹H-NMR (CDCl₃) δ 1.64 (t, J=6.6 Hz, 3H), 2.89 (s, 6H), 2.98 (q, J=6.6 Hz, 2H), 3.25 (t, J=6.2 Hz, 3H), 5.09 (br m, 1H), 7.19 (d, J=7.4 Hz, 1H), 7.51-7.59 (m, 2H), 8.26 (d, J=7.0 Hz, 1H), 8.29 (d, J=8.5 Hz, 1H), 8.56 (d, J=8.5 Hz, 1H); ¹³C-NMR (CDCl₃) δ 28.6, 40.4, 45.2 (2C), 48.4, 115.1, 118.5, 123.0, 128.3, 129.3, 129.4, 129.7, 130.4, 134.3, 151.8; IR (thin film, cm⁻¹) 3291, 2874, 2097, 1580, 1440, 1320, 893; MS m/z (relative intensity) 356 (M.Na) (26), 335 (M.2) (18), 334 (M.1) (100). HRMS calcd for C₁₅H₂₀N₅O₂S 334.1332, found 334.1332.

### Compound 6: 5-(Dimethylamino)-N,N-di(2-propynyl)-1-naphthalenesulfonamide

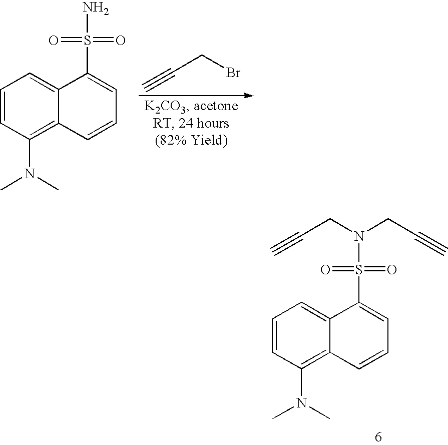

To a solution of dansylamide (5.0 g, 19.8 mmol) in acetone (150 mL), were added K₂CO₃ (13.7 g, 99.0 mmol) and propargyl bromide (8.3 g, 80% in toluene, 59.4). The reaction mixture was stirred at RT for 24 hours, the solid filtered off and the solvent evaporated under vacuum. The residue was purified by flash chromatography in silica gel (elutant, 20% EtOAc-Hexanes) to afford Compound 6 as yellow solid (5.3 g, 82% yield). R_{f}=0.3 (10% EtOAc-hexanes); mp: 68±1° C.; ¹H-NMR (CDCl₃) δ 2.16 (t, J=2.2 Hz, 2H), 2.88 (s, 6H), 4.24 (d, J=2.2 Hz, 4H), 7.19 (d, J=7.7 Hz, 1H), 7.51-7.58 (m, 2H), 8.25-8.27 (m, 2H), 8.57 (d, J=8.4 Hz, 4H); ¹³C-NMR (CDCl₃) δ 35.8, 45.4, 73.7, 76.6, 115.2, 119.3, 123.1, 128.2, 130.0, 130.1, 130.3, 131.0, 133.6, 151.7; IR (thin film, cm⁻¹) 3269, 2838, 2119, 1576, 1468, 1324, 1149, 947, 879, 790; MS m/z (relative intensity) 349 (M.Na) (11), 328 (M.2) (21), 327 (M.1) (100). Anal. Calcd for C₁₈H₁₆N₂O₂S.¼ H₂O: C, 65.33; H, 5.63; N, 8.47; S, 9.69. Found: C, 65.23; H, 5.43; N, 8.26; S, 9.68.

### Compound 7: 1,6-Diazidohexane

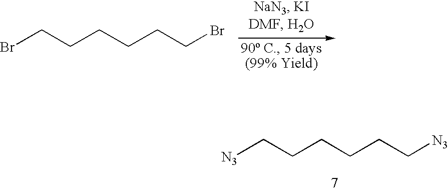

To a solution of 1,6-dibromohexane (13.2 g, 54.1 mmol) in a mixture DMF:H₂O (3:1.5) (200 mL) was added NaN₃ (10.7 g, 162.3 mmol) and KI (4.5 g, 27.1 mmol) at RT. The mixture was heated at 90° C. for 5 days under vigorous stirring, after which time the solution was cooled to RT and extracted with hexanes (3×250 mL). The combined organic phases were washed with H₂O (3×250 mL), dried (MgSO₄), filtered, and the solvent evaporated carefully under vacuum to afford Compound 7 (9.0 g, 99% yield) as pale yellow oil. ¹H-NMR (CDCl₃) δ 1.40-1.43 (m, 4H), 1.60-1.63 (m, 4H), 3.28 (t, J=7.0 Hz, 4H); ¹³C-NMR (CDCl₃) δ 26.1, 28.5, 51.1; IR (thin film, cm⁻¹) 2079, 1463, 1284, 902. Anal. Calcd for C₆H₁₂N₆: C, 42.84; H, 7.19; N, 49.96. Found: C, 42.59; H, 7.28; N, 50.11.

### Compounds 16 and 17

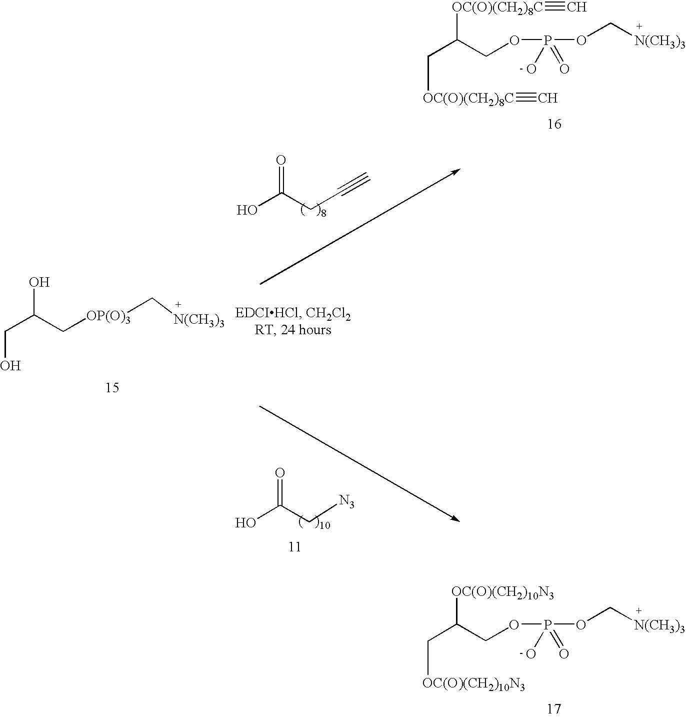

Compound 15, glycerophosphatidylcholine (GPC) is available from Sigma Chemical (St. Louis, Mo.) as a cadmium chloride complex or in methanol (G 8005 G 1381 G 4007 in MeOH). The cadmium can be removed by elution through an IRC-50 cation exchange column equilibrated with 100 mm potassium acetate, pH 6, whereas the methanol can be removed under reduced pressure. Separate reaction of Compound 15 with each of the depicted acids are carried out as discussed above for the preparation of Compounds 2 and 3 to provide phospholipid Compounds 16 and 17.

Approximately equimolar amounts of phospholipid Compounds 16 and 17 are dissolved in 70/30 wt/wt chloroform/dimethyl formamide at ambient temperature to provide a solution containing about 35 to about 45 weight percent of the phospholipids in the presence and absence of a catalytic amount of Cu^{I} catalyst. The resulting gelled solutions are electrospun following the techniques discussed in McKee et al., Science, 2006, 311:353-355 to form fiber mats. The mats of fibers formed in the presence of the copper catalyst resist dissolution in water, whereas those prepared in the absence of catalyst dissolve. Ranges of dissolution rates can be achieved by replacement of the reactive phospholipids with lecithin.

3. Gelation Ability.

Most of the chiral gelator racemates are either less efficient than their pure enantiomer counterparts, or do not have any gelation properties at all. The easier gel formation in the case of the pure enantiomers is normally attributable to the presence of much favored intermolecular hydrogen bonding. The “chiral bilayer effect” was formulated to explain why pure enantiomers prefer to gel, whereas racemates or amphiphilic gelators prefer to crystallize. [Fuhrhop et al., J. Am. Chem. Soc., 1987, 109:3387-3390] However, the effect of chirality on gelation is a topic of much controversy and until now it has not been possible to generalize. In some cases, chirality is an essential factor for gelation, whereas in other cases it is not a prerequisite. In addition, several racemates have been recently reported to exhibit better gelling properties for some solvents than pure enantiomer, leading questionable the general validity of the above effect. [(a) Makarević et al., Chem. Eur. J., 2003, 9:5567-5580; (b) D'Aléo et al., Chem. Commun., 2004, 190-191; (c) Watanabe et al., Org. Lett., 2004, 6:1547-1550]

Although the original work of Hanabusa and co-workers [Hanabusa et al., Angew. Chem. Int. Ed., 1996, 35:1949-1951] pointed out that the racemate of Compound 1 only formed an unstable gel, which was converted to co-crystals after several hours, we found that at much higher concentrations, some gels were stable for more than one month at room temperature. In addition, some gels were also fairly stable at the minimum gelator concentration, such as the gels made in silicone oil or nitrobenzene (vide infra). In other hand, crystallization could be prevented in some extent by adding a small amount of another solvent with a very different dielectric constant and thus tuning the polarity of the organic solvents used to form the gels.

It was decided to work with racemates for the present work, hoping to enhance the strength of the gels via metal-catalyzed AAC, as with Cu^{I} or Ru^{II}. The gelation properties of rac-2 and rac-3 in comparison to that of rac-1 were investigated in different organic solvents in order to determine the effect of the introduction of the azides and alkynes into the hydrophobic portions of the organogelator Compound 1. The gelation ability of rac-1 was also screened and compared with the data previously reported for the enantiomeric pure compound (R,R)-1.

The compounds were insoluble in most organic solvents at room temperature, but dissolved gradually above 60° C. Upon cooling, gels were formed in a variety of solvents as shown in Table 3. The stable gels were entirely thermoreversible. For comparative purposes it was decided to determine the minimum concentration (MC) in which some observable effect “takes place”. These values were thought to be more informative than those obtained if the gelator concentration were kept invariable.

Clearly, among the three LMOGs, Compound 1 was found to be a generally more efficient gelator than Compound 2 or Compound 3 in most solvents. The gelling capabilities of Compound 2 and Compound 3 were rather disappointing, although both compounds were able to form stable gels in acetonitrile at low concentrations.

The terminal group nature can be a critical factor in the gelation ability as can be observed in case of Compound 3. This was not a big surprise due to the different dipolar moment of an azide group versus a methyl group. The capability of the bisalkyne analogue Compound 2 was less understood. It is surprising that a transformation of a terminal methyl to a terminal acetylene results in such a marked difference of gelation properties. It is worth pointing out that effective gelation in solvents that strongly compete for hydrogen-bond formation, like DMSO, were also possible with Compound 2.

Although the gelation ability was decreased in the cases of Compound 2 and Compound 3, they both exhibited unique characteristics. For instance, the gels prepared with Compound 2 or Compound 3 in acetonitrile were stable for months at room temperature, whereas the gel prepared with Compound 1 was destroyed after a few hours by crystallization of the gelator.

TABLE 3

| | Gelator Compound | | | | | | | |
|---|---|---|---|---|---|---|---|---|
| | 1^{[b]} | | (±)−1 | | (±)−2 | | (±)−3 | |
| Solvent | MC | (State)^{[a]} | MC | (State) | MC | (State) | MC | (State) |
| hexane | 6 | (G) | 6 | (LG) | 6 | (G) | 6 | (LG) |
| methanol | 20 | (G) | 20 | (HCG) | 45 | (T) | 60 | (T) |
| ethyl acetate | 8 | (G) | 8 | (HCG) | 56 | (G) | 40 | (CG) |
| acetone | 10 | (G) | 10 | (HCG) | 50 | (G) | 40 | (G) |
| acetonitrile | 5 | (G) | 5 | (LCG) | 20 | (G) | 15 | (G) |
| pyridine | 25 | (G) | 25 | (T) | 75 | (T) | 100 | (T) |
| 1,4-dioxane | 12 | (G) | 12 | (R) | 100 | (T) | 60 | (T) |
| toluene | 12 | (G) | 12 | (CG) | 82 | (G) | 60 | (T) |
| chlorobenzene | 22 | (G) | 22 | (PG) | 88 | (T) | 100 | (T) |
| nitrobenzene | 12 | (G) | 12 | (G) | 82 | (G) | 70 | (G) |
| Dimethyl- | 12 | (G) | 12 | (G) | 66 | (T) | 24 | (G) |
| sulfoxide | | | | | | | | |
| N,N-dimethyl- | 10 | (G) | 10 | (PG) | 100 | (S) | 82 | (G) |
| formamide | | | | | | | | |
| silicone oil | 2 | (G) | 2 | (G) | 5 | (G) | 8 | (G) |
| N,N-dimethyl- | 11 | (G) | 11 | (CG) | 44 | (T) | 88 | (G) |
| acetamide | | | | | | | | |
| benzene | 20 | (G) | 20 | (R) | 100 | (T) | 60 | (T) |
| ^{[a]}State Abbreviations: G = stable gel; LG = loose gel upon mechanical disruption (shaking); PG = gel that leads to a precipitated material after a few days; T = turbid solution with particles in suspension; S = solution; CG = stable | | | | | | | | |
| # gel in which crystals appear after 24-48 hours without loose gel; R = recrystallization; P = precipitates; LCG = loose gel upon crystallization after 48 hours; HCG = heterogeneous gel that forms crystals after 2 hours. | | | | | | | | |

^{[b]}Values reported in units of g/dm³ (gelator/solvent) in Hanabusa at al., Angew. Chem. Int. Ed. 1996, 35: 1949-1951.

Most of the stable gels were homogeneous and can be stored at room temperature without disruption or precipitation at least over two months. Although these organogels can range from clear to opaque, depending on the choice of solvent, most of the gels obtained here were opaque, with increased opacity at higher concentrations of organogelator.

Transparent gels were formed in nitrobenzene and toluene at the minimum gelator concentration indicated in Table 3. These gels became opaque only at the higher concentrations. Importantly, the gelation was unaffected even in the presence of small amounts of cross-linker compounds.

The diffusion of soluble dyes through a representative gel was found to be independent of size of the dye molecules and complete saturation of the gel required several hours.

4. Typical FT-IR Spectra of Gel Samples

IR spectra of gels were obtained by depositing the gel on a horizontal attenuated total reflectance (HATR) plate and recording the spectrum directly. No correction was made for the solvent.

5. Typical NMR Spectra of Gel Samples

¹H NMR (CDCl₃, 500 MHz, 298 K) obtained after evaporation of the solvent from the gel show the —CH pattern of 1,4-triazole ring hydrogen at about 7.24 ppm.

Each of the patents and articles cited herein is incorporated by reference. The use of the article “a” or “an” is intended to include one or more.

The foregoing description and the examples are intended as illustrative and are not to be taken as limiting. Still other variations within the spirit and scope of this invention are possible and will readily present themselves to those skilled in the art.

What is claimed:

1. A gel that comprises:
a reaction product containing a plurality of 1,2,3-triazole rings, said reaction product formed by the reaction between (a) a first gelator that includes an alkyne or azide functionality, (b) a modulator molecule including a gel property-modifying entity linked to the other of an azide or alkyne functionality that is not present in the first gelator, and (c) an optionally present second gelator molecule, said reaction forming 1,2,3-triazole rings in a reaction mixture that is an admixture of (a), (b), and (c) when present, in the presence of a catalyst and a solvent for one, another, all or any combination of (a), (b) and (c),
said gel exhibiting properties different from those of a first gel formed from the admixture, in the absence of a catalyst, of the same amounts of (a), (b), and (c) present in the reaction mixture.

2. The gel according to claim 1 wherein the first gelator forms a hydrogel.

3. The gel according to claim 1 wherein the first gelator forms an organogel.

4. The gel according to claim 1 wherein the first gelator molecule contains two alkyne or azide functionalities.

5. The gel according to claim 1 wherein the modulator molecule contains two azide or alkyne functionalities.

6. The gel according to claim 1 wherein the first gelator molecule contains an alkyne or azide functionality.

7. The gel according to claim 1 wherein the modulator molecule contains an alkyne or azide functionality.

8. The gel according to claim 1 wherein a first gelator molecule has a molecular weight of less than about 3000 Da.

9. The gel according to claim 1 wherein said 1,2,3-triazole rings are 1,5-disubstituted triazole rings.

10. The gel according to claim 1 wherein said 1,2,3-triazole rings are 1,4-disubstituted triazole rings.

11. The gel according to claim 1 that contains copper or ruthenium or both at a concentration greater than a background, impurity level.

12. A method for modifying the properties of a gel that comprises the steps of:
a) admixing (i) a first gelator including an alkyne or azide functionality, (ii) an optional second gelator, and (iii) a modulator molecule containing the other of an azide or alkyne functionality that is not present in the first gelator and including a gel property-modifying entity, said admixture being carried out in the presence of a catalyst and a solvent for one, another, all or any combination of (a), (b) and (c), to form a reaction mixture containing a gel with first properties under first predetermined conditions; and
c) maintaining said reaction mixture for a time period and at a temperature sufficient for said the terminal alkyne and azide functionalities present to react to form a 1,2,3-triazole bonded to the first gelator and to the gel property-modifying entity to form a second composition that forms a second gel having properties different from those of the first gel formed from the admixture, in the absence of a catalyst, of the same amounts of (a), (b), and (c) present in the reaction mixture.

13. The method according to claim 12 wherein the first gelator forms a hydrogel.

14. The method according to claim 12 wherein the first gelator forms an organogel.

15. The method according to claim 12 wherein the first gelator molecule contains two alkyne or azide functionalities.

16. The method according to claim 12 wherein the modulator molecule contains two azide or alkyne functionalities.

17. The method according to claim 12 wherein the first gelator molecule contains one terminal alkyne or azide functionality.

18. The method according to claim 12 wherein the modulator molecule contains one terminal alkyne or azide functionality.

19. The method according to claim 12 wherein a second gelator is present in the composition.

20. The method according to claim 19 wherein said first gelator is present at about 90 to about 10 mole percent of the gelators present in the composition.

21. A method for modifying the properties of a gel that comprises the steps of:
a) admixing (i) a first gelator molecule, (ii) a second gelator molecule, said first and second gelator molecules forming a gel with first properties under first predetermined conditions, said first gelator molecules including one or two terminal alkyne or azide functionalities per molecule and present at about 90 to about 10 mole percent of the gelators present and (iii) a modulator molecule containing one or two of the other of a terminal azide or alkyne functionalities per molecule that is not present in the first gelator molecule and including a gel property-modifying entity, said admixture being carried out in the presence of a solvent for one, two or all of (i), (ii) and (iii) to form a reaction mixture and
c) maintaining said reaction mixture in the presence of a catalyst for a time period and at a temperature sufficient for the terminal alkyne and azide functionalities present to react to form a 1,2,3-triazole bonded to the first gelator and to the gel property-modifying entity to form a second a second gel having properties different from those of a first gel formed from the admixture, in the absence of a catalyst, of the same amounts of (a), (b), and (c) present in the reaction mixture.

22. The method according to claim 21 wherein each first gelator molecule contains two terminal alkyne or azide functionalities and each modulator molecule contains two of the other of terminal azide or alkyne functionalities.

23. The method according to claim 21 wherein each first gelator molecule contains two terminal alkyne or azide functionalities and each modulator molecule contains one of the other of terminal azide or alkyne functionalities.

24. The method according to claim 21 wherein each first gelator molecule contains one terminal alkyne or azide functionalities and each modulator molecule contains two of the other of terminal azide or alkyne functionalities.

25. The method according to claim 21 wherein each first gelator molecule contains one terminal alkyne or azide functionalities and each modulator molecule contains one of the other of terminal azide or alkyne functionalities.

26. The method according to claim 21 wherein reaction of said modulator molecule raises the gel-to-sol transition temperature.

27. The method according to claim 21 wherein reaction of said modulator molecule lowers the gel-to-sol transition temperature.

28. The method according to claim 21 wherein a first gelator molecule has a molecular weight of less than about 3000 Da.

29. The method according to claim 21 wherein the reaction between the terminal alkyne and azide functionalities is carried out in the presence of a copper(I) or a Ru(II) catalyst.

30. The method according to claim 21 wherein the first gelator is in solution when admixed with the modulator molecule.

31. The method according to claim 21 wherein the first gelator is gelled when admixed with the modulator molecule.

32. The method according to claim 21 wherein the first gelator, the second gelator and modulator molecule are in solution when admixed.

33. A method for modifying the properties of a gel that comprises the steps of:
a) providing a composition comprised of a first organogelator and a second organogelator dissolved in a solvent that forms a first organogel with first properties under first predetermined conditions and wherein the first organogelator includes a terminal alkyne or azide functionality;
b) admixing the first and second organogelator-containing composition with a modulator molecule containing the other of a terminal azide or alkyne functionality that is not present in the second organogelator and is bonded to a gel property-modifying entity, said admixture being carried out in the presence of a catalytic amount of copper (I) ions to form a reaction mixture; and
c) maintaining said reaction mixture for a time period and at a temperature sufficient for the terminal alkyne and azide functionalities present to react to form a 1,2,3-triazole 1,4-bonded to the first organogelator and to the gel property-modifying entity to form a second composition that forms a second organogel under second conditions and exhibits second properties.

34. A method for modifying the properties of a gel that comprises the steps of:
a) providing a composition comprised of a first hydrogelator and a second hydrogelator dissolved in an aqueous solvent that forms a first hydrogel with first properties under first predetermined conditions and wherein the first hydrogelator includes a terminal alkyne or azide functionality;
b) admixing the first and second hydrogelator-containing composition with a modulator molecule containing the other of a terminal azide or alkyne functionality that is not present in the second organogelator and is bonded to a gel property-modifying entity, said admixture being carried out in the presence of a catalytic amount of copper(I) ions to form a reaction mixture; and
c) maintaining said reaction mixture for a time period and at a temperature sufficient for the terminal alkyne and azide functionalities present to react to form a 1,2,3-triazole 1,4-bonded to the first hydrogelator and to the gel property-modifying entity to form a second composition that forms a second hydrogel under second conditions and exhibits second properties.
